(19) United States
(12) Patent Application Publication
(10) Pub. No.: US 2007/0002552 A1
(43) Pub. Date: Jan. 4, 2007

(54) Light guide polygonal cones in direct type backlight module

(75) Inventor: Wen-Pao Tseng, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/171,374

(22) Filed: Jul. 1, 2005

(51) Int. Cl. G01D 11/28

(52) U.S. Cl. 362/29; 362/30; 362/333

(57) ABSTRACT

A light guide construction adapted in direct type backlight module comprised in sequence from inside to outside a reflector hood, multiple light sources, a diffuser, multiple optical films, and a liquid crystal panel; multiple light guide polygonal cones being disposed on a light inlet surface and a light outlet surface of the diffuser for the light passing through the light guide to be diffused at least twice by those polygonal cones for more effective light distribution.

### BACKGROUND OF THE INVENTION

(a) Field of the Invention

The present invention is related to a light guide construction in backlight module, and more particularly to one applied in direct type backlight module.

(b) Description of the Prior Art

Depending on the design requirements, directly type or side-edge backlight module configuration is selected for an LCD applied in information device. FIG. 1 of the accompanying drawings shows a basic construction of a direct type backlight module configuration, the entire backlight module is comprised of a reflector hood 10, multiple light sources 20, a diffuser plate 30, multiple optical films 40, and a liquid crystal panel 50 arranged in sequence from inside to outside. Wherein, each light source 20 is made in the form of a straight tube, a U-shaped tube, or a snake shaped tube, and all those light sources 20 are distributed with a proper spacing at where between the reflector hood 10 and the diffuser plate 30. For those backlight modules generally available in the market, multiple optical films 40 are comprised of combinations of 1˜3 diffuser plate, 0˜2 brightness enhancing film (BEF), and 0˜1 reflective polarizer to diffuse the light passing through and thus to correct the alternatively bright and dark bands created on the liquid crystal module due to the position of the spacing between any two abutted light sources.

Furthermore, the only purpose of the diffuser plate 30 is consistently diffuse the light passing through it, and has very limited results on improving the phenomenon of alternatively bright and dark bands created on the liquid crystal module. Therefore, even certain backlight modules have on purpose extended the spacing between those light sources 20 and the diffuser plate 30 to allow expanded area for the light from each light source 20 to enter into the diffuser plate 30 so to reduce the area of the alternatively bright and dark bands, such a design gives very little effects. Also, the backlight module is thickened, violating the basic design requirements of staying compact.

### SUMMARY OF THE INVENTION

The primary purpose of the present invention is related to a light guide construction for direct type backlight module to provide an even active and positive means to eliminate the alternatively bright and dark bands otherwise created on the backlight module of the prior art and offer a solution for more effective distribution of the light emitted form the light source. To achieve the purpose, the present invention is comprised of a reflector hood, multiple light sources, a diffuser plate, multiple optical films and a liquid crystal panel arranged in sequence form inside to outside. Wherein, multiple light guide polygonal cones are provided on the light inlet surface and light out surface of the diffuser plate so that the light before entering into the liquid crystal panel is diffused at least twice by those light guide polygonal cones.

### BRIEF DESCRIPTION OF THE DRAWINGS

FIG. 1 is a schematic view showing a construction of a direct type backlight module of the prior art.

FIG. 2 is a schematic view showing an application layout of a direct type backlight module of the present invention.

FIG. 3 is a perspective view of a diffuser plate used in the present invention.

FIG. 4(A) is a perspective view of another construction of the light guide of the present invention.

FIG. 4(B) is a cut-away showing a magnified polygonal cone taken from FIG. 4(A).

FIG. 5(A) is a perspective view of another construction yet of the light guide of the present invention.

FIG. 5(B) is a cut-away showing a magnified polygonal cone taken from FIG. 5(A).

FIG. 6(A) is a perspective view of another construction yet of the light guide of the present invention.

FIG. 6(B) is a cut-away showing a magnified polygonal cone taken from FIG. 6(A).

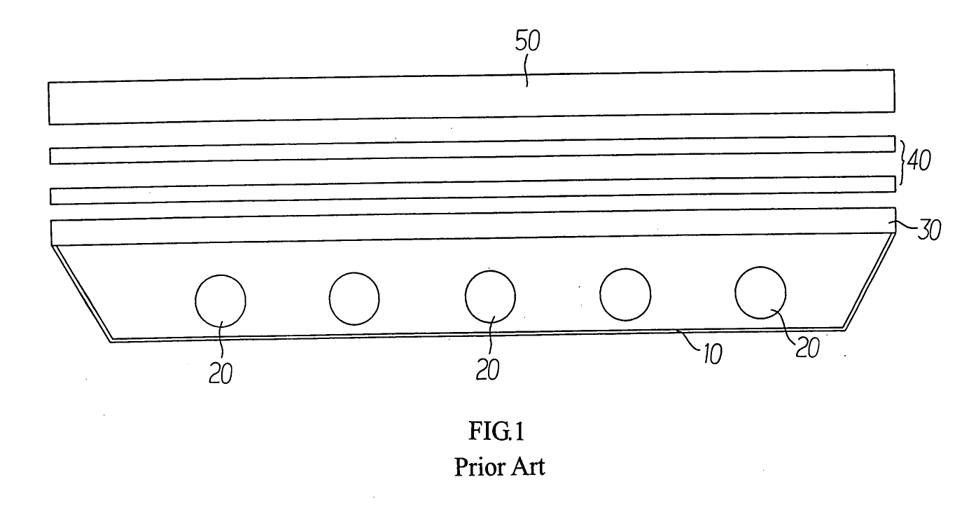

### DETAILED DESCRIPTION OF THE PREFERRED EMBODIMENTS

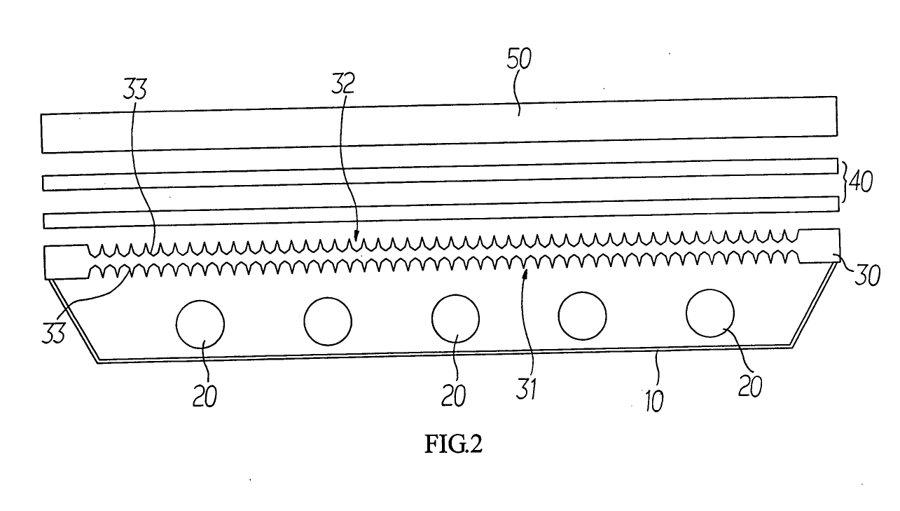

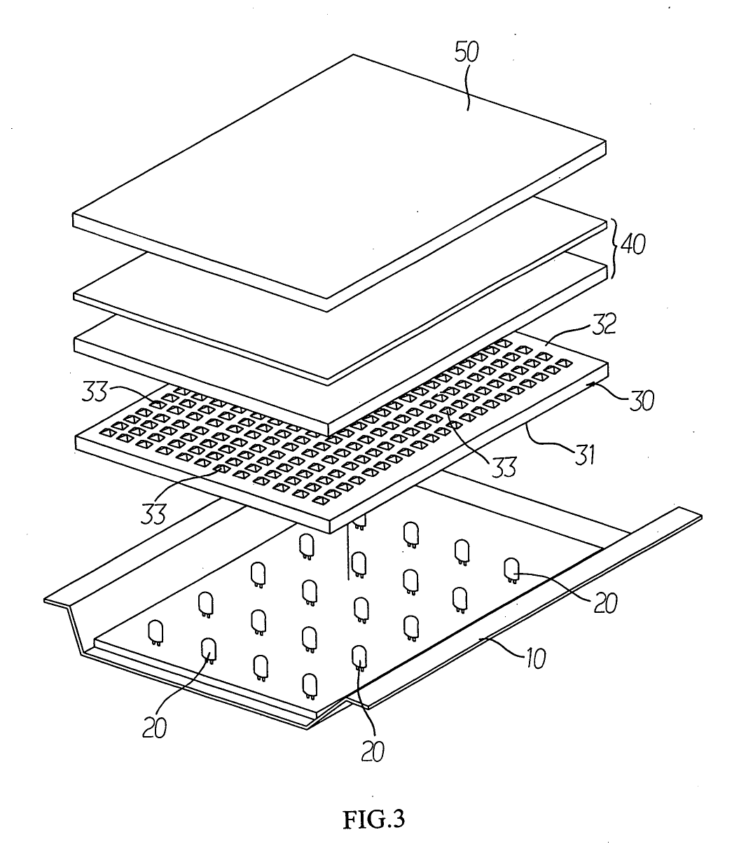

Referring to FIG. 2 for a construction of a light guide of the present invention applied in a direct type backlight module, the direct type backlight module is comprised of a reflector hood 10, multiple light sources 20, a diffuser plate 30, multiple optical films 40, and a liquid crystal panel 50 arranged in sequence from inside to outside. Wherein, those multiple optical films 40 are comprised of combinations of 1˜3 diffuser plate, 0˜2 brightness enhancing film (BEF), and 0˜1 reflective polarizer. Each light source 20 is made in the form of a straight tube, a U-shaped tube, or a snake shaped tube, and all those light sources 20 are distributed with a proper spacing at where between the reflector hood 10 and the diffuser plate 30; or alternatively, multiple LEDs are arranged with a proper spacing at where between the reflector hold 10 and the diffuser plate 30 as illustrated in FIG. 3. Light emitted from each of those multiple light sources 20 constitutes those effects displayed by the liquid crystal module.

The present invention is characterized by that multiple light guide polygonal cones 33 are provided on a light inlet surface 31 and a light out surface 32 of the diffuser plate 30. In the preferred embodiment, the spacing between any two abutted polygonal cones 33 is not greater than 1 mm. The light from each light source 20 before entering into the liquid crystal panel 50 is diffused at least twice by those light guide polygonal cones 33 of the diffuser plate 30 for the direct type backlight module to produce the expected presentation of luminance thus to provide an even active and positive means to eliminate the alternatively bright and dark bands otherwise created on the backlight module of the prior art and offer a solution for more effective distribution of the light emitted form the light source.

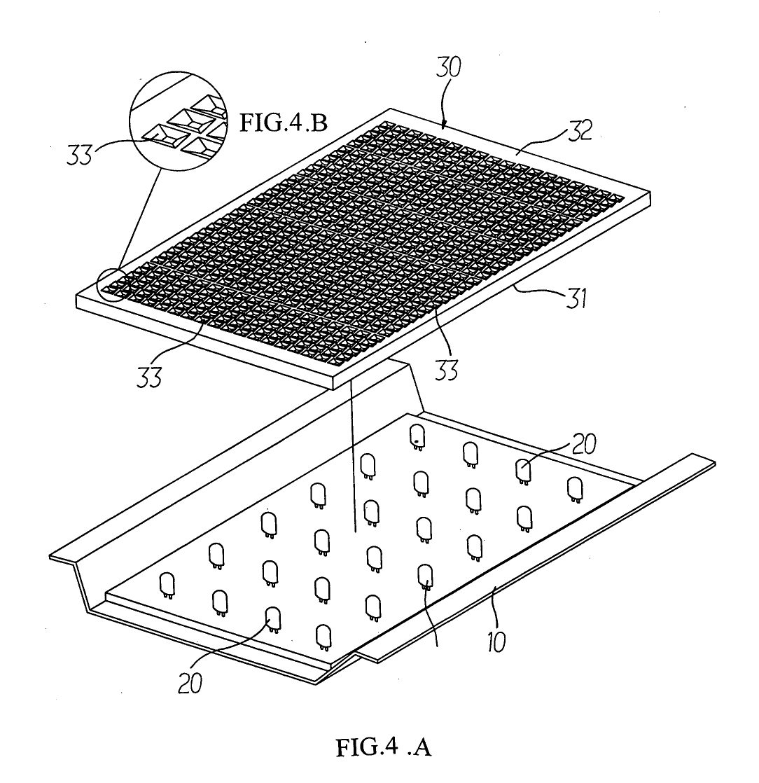

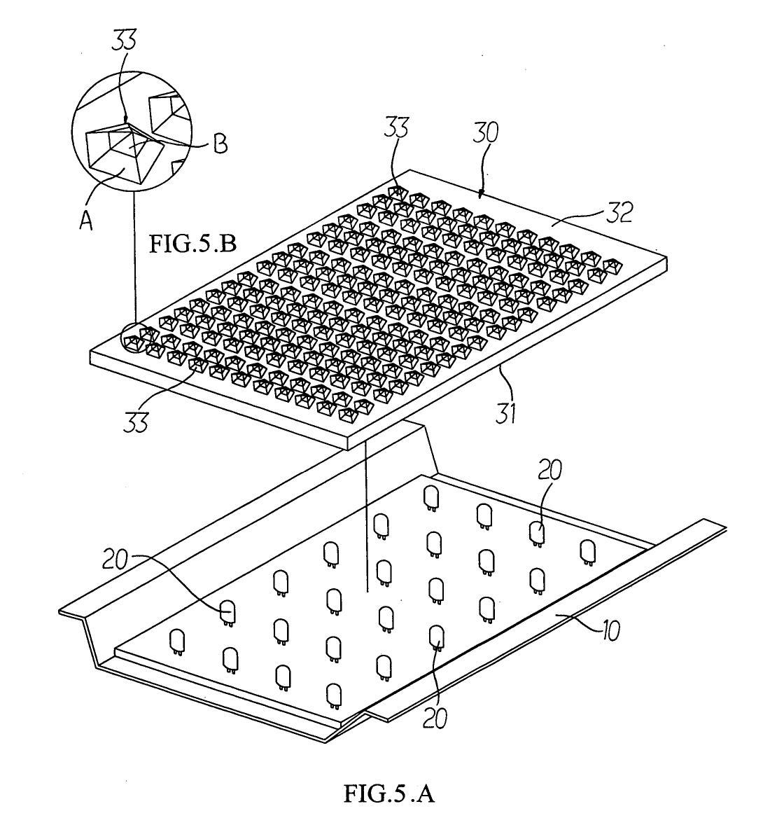

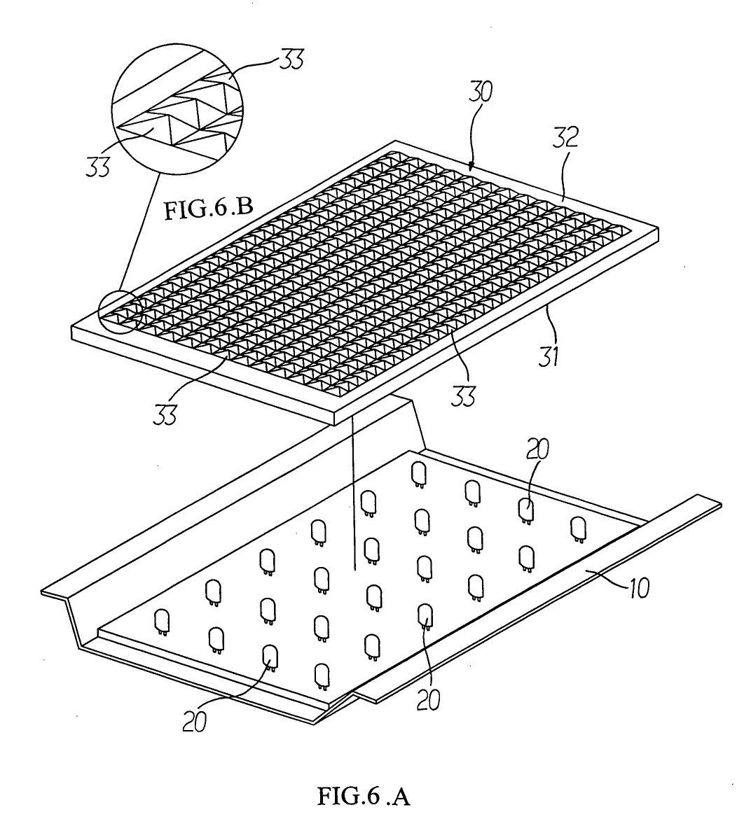

As illustrated in FIGS. 3, 4(A), and 4(B), the light guide polygonal cone 33 is comprised of multiple protrusions from the diffuser plate 30 with each polygonal cone 33 in a height not greater than 0.5 mm in the preferred embodiment; or alternatively as illustrated in FIGS. 4(A) and 4(B), the light guide polygonal cone 33 is comprised of multiple pits with each in a depth not greater than 0.5 mm. In either case, all the light guide polygonal cones 33 directly extend from the diffuser plate 30. Each cone of the polygonal cones 33 may be made of two different tapers A and B as illustrated in FIGS. 5(A) and 5(B). Those polygonal cones 33 may be arranged in multiple blocks with polygonal cones 33 abutted to one another in each block as illustrated in FIGS. 6(A) and 6(B), or not abutted to one another within each block as illustrated in FIGS. 3, 4(A), 4(B), 5(A) and 5(B).

The prevent invention provides an improved structure of a light guide construction for direct type backlight module, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A light guide construction of direct type backlight module comprised of a reflector hood, multiple light sources, a diffuser plate, multiple optical films and a liquid crystal panel arranged in sequence form inside to outside; and multiple light guide polygonal cones are provided on the light inlet surface and light out surface of the diffuser plate so that the light before entering into the liquid crystal panel is diffused at least twice by those light guide polygonal cones to more effectively distribute the light emitted from those light sources.

2. The light guide construction of direct type backlight module of claim 1, wherein each light source is made in the form of a straight tube, a U-shaped tube, or a snake shaped tube and all light sources are distributed with a proper spacing between the reflector hood and the diffuser plate.

3. The light guide construction of direct type backlight module of claim 1, wherein each light source is related to a light emitting diode and all light emitting diodes are distributed with a proper spacing between the reflector hood and the diffuser plate.

4. The light guide construction of direct type backlight module of claim 1, wherein each light guide polygonal cone extends directly from a protrusion of the diffuser plate.

5. The light guide construction of direct type backlight module of claim 1, wherein each light guide polygonal cone directly extends from a pit of the diffuser plate.

6. The light guide construction of direct type backlight module of claim 1, wherein each light guide polygonal cone is made in a U shape or V shape directly extends from diffuser plate.

7. The light guide construction of direct type backlight module of claim 1, wherein the spacing between any two abutted light guide polygonal cones is not greater than 1 mm.

8. The light guide construction of direct type backlight module of claim 4, wherein the height of each light polygonal cone is not greater than 0.5 mm

9. The light guide construction of direct type backlight module of claim 5, wherein the depth of each light polygonal cone is not greater than 0.5 mm.
